(19) United States
(12) Patent Application Publication
(10) Pub. No.: US 2014/0257703 A1
(43) Pub. Date: Sep. 11, 2014

(54) Real-Time Formation Anisotropy And Dip Evaluation Using Multiaxial Induction Measurements

(71) Applicants: Peter T. Wu, Missouri City, TX (US); Thomas D. Barber, Houston, TX (US)

(72) Inventors: Peter T. Wu, Missouri City, TX (US); Thomas D. Barber, Houston, TX (US)

(73) Assignee: SCHLUMBERGER TECHNOLOGY CORPORATION, Sugar Land, TX (US)

(21) Appl. No.: 14/343,362

(22) PCT Filed: Sep. 9, 2012
(86) PCT No.: PCT/US2012/053746

§ 371 Date: May 12, 2014

Related U.S. Application Data
(60) Provisional application No. 61/532,612, filed on Sep. 9, 2011.

(51) Int. Cl. G01V 3/38; E21B 49/00; G01V 3/18

(52) U.S. Cl. CPC G01V 3/38; G01V 3/18; E21B 49/00
USPC 702/7; 702/11

(57) ABSTRACT

Methods and systems are provided for logging a formation by combining results for a zero-dimensional inversion of conductivity measurements with results for a higher-order inversion of a subset of the conductivity measurement. The higher order inversion can include a 1D-radial portion and a 1D-axial portion. The combined results can include formation characteristics such as Rh, Rv, dip, and azimuth.

### BACKGROUND

This disclosure relates generally to the field of electrical conductivity measurements of formations penetrated by a wellbore. More specifically, the disclosure relates to processing multiaxial electromagnetic induction measurements to obtain real-time formation anisotropy and dip information.

Measuring formations properties of a formation from within a wellbore using some conventional 3D triaxial electromagnetic induction tools generally includes measuring 9 component apparent conductivity tensors (σm(i,j,k), j,k=1,2,3), at multiple distances between an electromagnetic transmitter and the respective receivers, represented by index i. FIG. 2A illustrates an example arrangement of transmitters and receivers, and shows as a vector the nine component apparent conductivity tensor for one distance (spacing). FIG. 2B shows an arrangement of a transmitter and one receiver on such a triaxial measurement. The typical receiver will include a main receiver and a compensating or “bucking” receiver to cancel effects of direct induction between the transmitter and the main receiver.

The measurements are usually obtained in the frequency domain by operating the transmitter with a continuous wave (CW) of one or more discrete frequencies to enhance the signal-to-noise ratio. However, measurements of the same information content could also be obtained and used from time domain signals through a Fourier decomposition process. This is a well known physics principle of frequency-time duality.

Formation properties, such as horizontal and vertical conductivities (σh, σv), relative dip angle (θ) and the dip azimuthal direction (Φ), as well as borehole/tool properties, such as mud conductivity (σmud), hole diameter (hd), tool eccentering distance (decc), tool eccentering azimuthal angle (ψ), all affect these conductivity tensors. FIG. 3A illustrates a top view, and FIG. 3B illustrates an oblique view of an eccentered multiaxial induction tool disposed in a borehole drilled through an anisotropic formation with a dip angle. Using a simplified model of layered anisotropic formation traversed obliquely by a borehole, the response of the conductivity tensors depends on the above 8 parameters (σh,σv, θ, Φ, σmud, hd, decc, ψ) in a very complicated manner. The effects of the borehole/tool to the measured conductivity tensors may be very big even in oil base mud (OBM) environment. Through an inversion technique, the above borehole/formation parameters can be calculated and the borehole effects can be removed from the measured conductivity tensor. In FIGS. 3A and 3B, X and Z are axes of the coordinate system fixed on the borehole, the Y axis is perpendicular to X an Z is in the direction into the paper (right-hand-rule) θ and Φ are the relative dip and dip azimuth of the formation, respectively, decc is the tool eccentering distance and ψ is the azimuth of eccentering.

After the borehole correction, the borehole corrected measurements may be further processed with a simplified model which does not contain a borehole. For example, one may use a simple model of uniform anisotropic formation with arbitrary dip angle with respect to the tool as illustrated in top view in FIG. 4A and in oblique view in FIG. 4B. The foregoing model can be called a zero-dimensional (ZD) model because the model formation does not have variation in the axial and radial direction of the tool. Example implementations of the ZD model are described in more detail in International Patent Application Publication No. WO2011/091216, the contents of which are hereby incorporated by reference in their entirely. In the ZD model, the controlling parameters are formation horizontal (Rh) and vertical (Rv) resistivities, the relative dip angle (θ) and the dip azimuth angle (Φ). In actual well logging conditions, the foregoing formation properties are generally unknown. Given the unknown parameters in such environment, the simple ZD model is actually the most versatile processing model to be used to generate coarse estimates of formation properties over the wellbore (borehole) path. These coarse Rh, Rv, dip, and azimuth values (presented with respect to depth, called a “log”) could be used to define zones where other higher order model inversion is applicable. For example, 1D inversion (e.g., Wang et al, “Triaxial Induction Logging, Theory, Modeling, Inversion, and Interpretation” SPE 103897, 2006, incorporated herein by reference) is appropriate to improve the vertical resolution of the Rh and Rv logs over a zone where Rh and Rv are varying but the dip and azimuth are almost constant.

Before multiaxial induction tools were invented, most of the induction tools only used axial coils or ZZ coils (coils with magnetic moment directed along the axial direction, or Z coordinate direction, of the tool) for the measurement. Such a ZZ coil tool could effectively measure only horizontal resistivity in a vertical well through horizontally layered formations, or any combination of well inclination and formation dip where the tool axis was perpendicular to the bedding planes). For many hydrocarbon bearing zones, the condition of vertical wells through horizontally layered formations is not common. The formations usually are characterized by Rh, Rv, dip, and azimuth of the layers. The apparent conductivity tensor measured by the triaxial induction tool is sensitive to the above formation parameters. Various inversion techniques, such as axial ZD and 1D inversion (e.g., Wang et al, “Triaxial Induction Logging, Theory, Modeling, Inversion, and Interpretation” SPE 103897, 2006, incorporated herein by reference), have been developed to solve for the formation parameters from the triaxial measurements. The axial 1D inversion model allows layered anisotropic formations to have different Rh and Rv values for each layer. However, the axial 1D inversion model requires the dip and azimuth of all the anisotropic layers within the processing window to be the same. If those assumed model conditions actually exist, the axial 1D inversion could produce higher resolution Rh and Rv logs in each layer than those from ZD inversion. The results are free from adjacent layer (“shoulder bed”) effects.

Under actual well logging condition, the dip and azimuth of the formations are generally not well known and may be highly variable. If one applies axial 1D inversion indiscriminately, there is no effective way to discern whether the axial 1D model assumptions are met or not. Therefore, the validity of the resultant logs becomes questionable.

Through extensive study using model data and real logs, it is apparent that the Rh, dip, and azimuth logs from ZD inversions have a reasonably good vertical response, while the Rv log is often distinctly has poorer vertical response compared with Rh, dip, and azimuth logs. Consequently, the ZD's Rv log often misses the true Rv value of thin beds of thickness of 1 to several feet.

More specifically, the results from RADAR processing, which is a service mark of Schlumberger Technology Corporation, Sugar Land, Tex., e.g., conventional inversion processing, which is a mark of the assignee of the present invention, currently used in tools such as the RT SCANNER tool, which is also a mark Schlumberger Technology Corporation, Sugar Land, Tex., and as described more fully in International Application Publication No. WO2011/091216, hereby incorporated by reference) or ZD processing show that most of the formations encountered in the subsurface are 3D formations.

Under normal logging conditions, the dip and azimuth of the formation are unknown and generally highly variable, even for vertical wells. If one applies axial 1D inversion indiscriminately, there is no effective way to discern whether the axial 1D model assumptions are met or not. Therefore, the validity of the resultant logs, and/or the quality of the inversion results, becomes questionable.

Accordingly, there is a need in the art for methods and systems for obtaining and processing downhole conductivity measurements that overcome one or more of the deficiencies that exist with conventional methods.

### SUMMARY

A method for logging a formation according to one aspect includes obtaining a plurality of multiaxial electromagnetic conductivity measurements from the formation. A zero-dimensional inversion on the plurality of conductivity measurements is performed, yielding zero-dimensional inversion results. A first portion of the results from the zero-dimensional inversion is identified for processing with a higher-order inversion. The higher-order inversion is performed on the first portion, yielding higher-order inversion results. The zero-dimensional inversion results are combined with the higher-order inversion results to form composite outputs for formation characteristics.

### BRIEF DESCRIPTION OF THE DRAWINGS

FIG. 1 shows an example wellsite measurement system.

FIGS. 2A and 2B show, respectively, an explanation of a multiaxial resistivity tensor and an example triaxial transmitter and receiver arrangement.

FIGS. 3A and 3B show a well logging instrument eccentered in a wellbore in top view and oblique view, respectively.

FIGS. 4A and 4B show a well logging instrument eccentered in a wellbore in top view and oblique view, respectively to demonstrate results of zero dimensional (ZD) modeling.

FIG. 5 shows a flow chart of an example hierarchical data processing method.

FIG. 6 shows a flow chart of an example zero dimensional inversion processing method.

FIG. 7 shows a flow chart of an example method to identify formations (zones) suitable for ZD processing, 1-D axial processing or 1-D radial processing.

FIG. 8 shows a flow chart for an example method for selecting high quality ZD processing outputs.

FIG. 9 shows a modeled formation and example ZD processing outputs therefrom.

FIG. 10 shows an example comparison of ZD and 1-D processing for a model set of formations.

FIG. 11 shows example ZD processing output with reference to the ZD indicator flag.

FIG. 12 shows an example computer and/or processor system that may be used in some examples.

### DETAILED DESCRIPTION

The present disclosure systems and methods for logging a subsurface formation by combining results for a zero-dimensional inversion of multiaxial induction conductivity measurements with results for a higher-order inversion of a subset of the conductivity measurements.

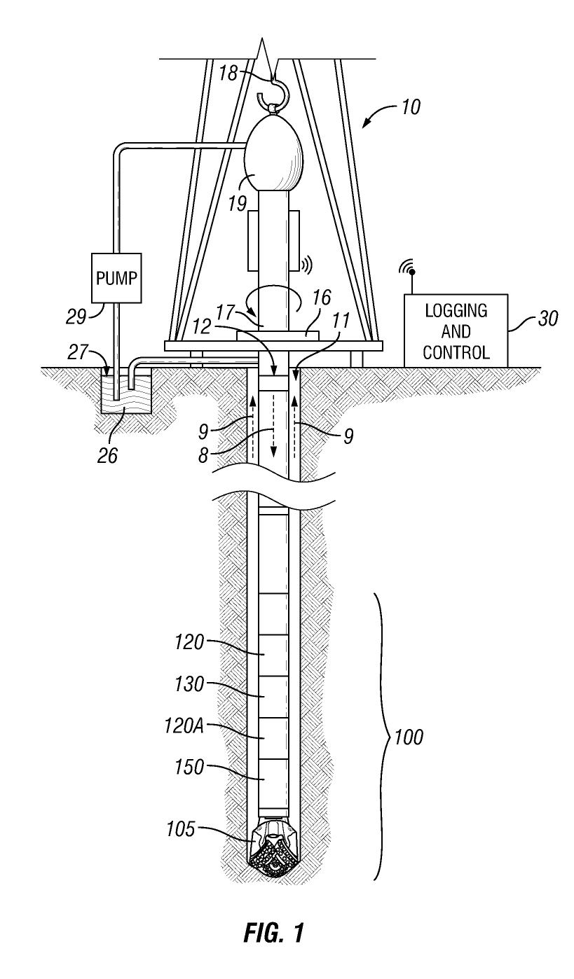

FIG. 1 illustrates a wellsite system in which the present example can be used. The wellsite can be onshore or offshore. In this example system, a borehole 11 is formed in subsurface formations by rotary drilling in a manner that is well known. Other examples can also use directional drilling, as will be described hereinafter.

A drill string 12 is suspended within the borehole 11 and has a bottom hole assembly 100 which includes a drill bit 105 at its lower end. The surface system includes platform and derrick assembly 10 positioned over the borehole 11, the assembly 10 including a rotary table 16, kelly 17, hook 18 and rotary swivel 19. The drill string 12 is rotated by the rotary table 16, energized by means not shown, which engages the kelly 17 at the upper end of the drill string. The drill string 12 is suspended from a hook 18, attached to a traveling block (also not shown), through the kelly 17 and a rotary swivel 19 which permits rotation of the drill string relative to the hook. As is well known, a top drive system could alternatively be used.

In the present example, the surface system further includes drilling fluid or mud 26 stored in a pit 27 formed at the well site. A pump 29 delivers the drilling fluid 26 to the interior of the drill string 12 via a port in the swivel 19, causing the drilling fluid to flow downwardly through the drill string 12 as indicated by the directional arrow 8. The drilling fluid exits the drill string 12 via ports in the drill bit 105, and then circulates upwardly through the annulus region between the outside of the drill string and the wall of the borehole, as indicated by the directional arrows 9. In this well known manner, the drilling fluid lubricates the drill bit 105 and carries formation cuttings up to the surface as it is returned to the pit 27 for recirculation.

The bottom hole assembly 100 of the illustrated embodiment a logging-while-drilling (LWD) module 120, a measuring-while-drilling (MWD) module 130, a rotary-steerable directional drilling system and motor, and drill bit 105.

The LWD module 120 may be housed in a special type of drill collar, as is known in the art, and may contain one or a plurality of known types of logging tools. It will also be understood that more than one LWD and/or MWD module can be employed, e.g. as represented at 120A. (References, throughout, to a module at the position of 120 can alternatively mean a module at the position of 120A as well.) The LWD module includes capabilities for measuring, processing, and storing information, as well as for communicating with the surface equipment. In the present embodiment, the LWD module includes a directional resistivity measuring device.

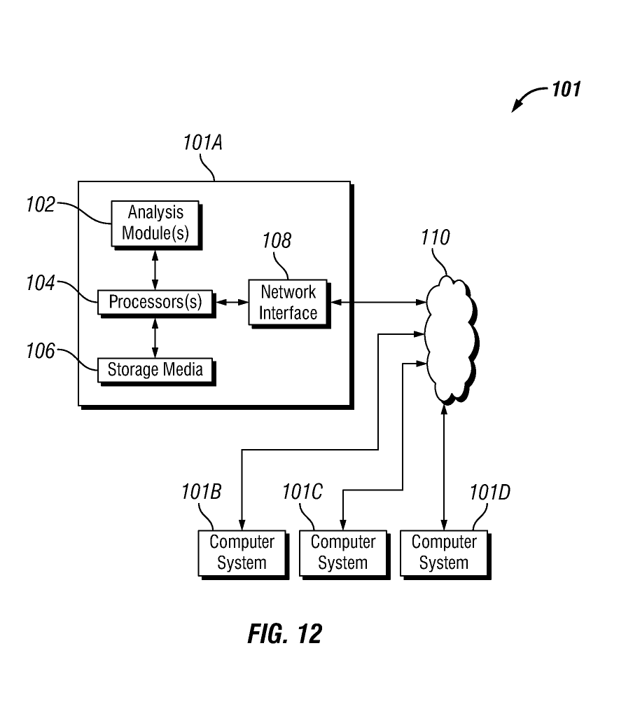

The MWD module 130 is also housed in a special type of drill collar, as is known in the art, and can contain one or more devices for measuring characteristics of the drill string and drill bit. The MWD tool further includes an apparatus (not shown) for generating electrical power to the downhole system. This may typically include a mud turbine generator powered by the flow of the drilling fluid, it being understood that other power and/or battery systems may be employed. In the present embodiment, the MWD module includes one or more of the following types of measuring devices: a weight-on-bit measuring device, a torque measuring device, a vibration measuring device, a shock measuring device, a stick slip measuring device, a direction measuring device, and an inclination measuring device. Measurements made by the MWD and LWD modules may be communicated to a control unit 30 disposed at the surface. The control unit 30 may include recording and/or data processing instruments as will be mode fully explained with reference to FIG. 12.

Although FIG. 1 shows example components of a wellsite system that includes a drill string and LWD and MWD modules, the various aspects of the present disclosure can apply equally to various other types of wellsite systems. For example, the disclosure could apply to tools and tool strings conveyed by wireline, drill pipe, wired drill pipe, and/or coiled tubing drill, or other methods of conveyance known in the art.

As discussed above, measurements made by multiaxial induction tools are generally input into an inversion process. Various aspects of example methods for inverting and otherwise processing the conductivity-related measurements obtained by induction tools are discussed herein.

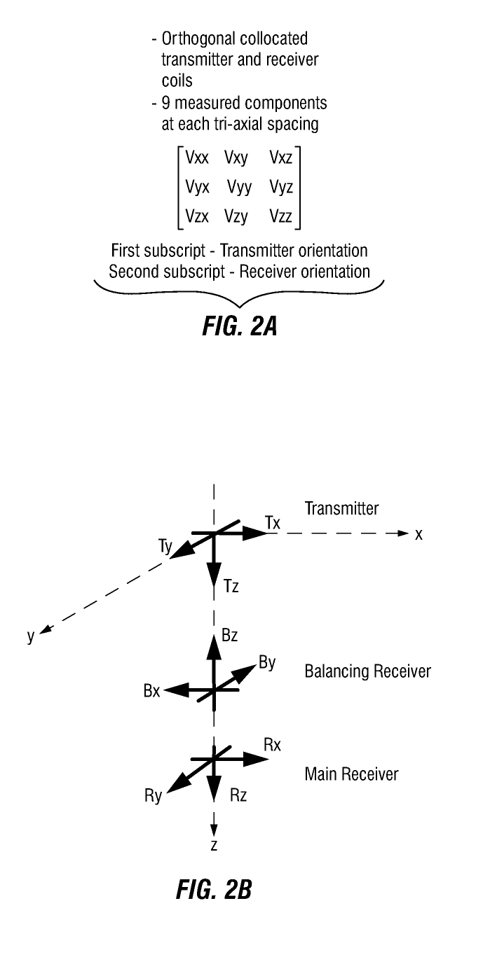

In example embodiments, the RADAR processing or ZD processing or other higher resolution processing can be performed using data measured using multiaxial electromagnetic receivers spaced at various longitudinal distances from a multiaxial electromagnetic transmitter. While the present example is directed to triaxial induction well logging tools, wherein the transmitter and receivers consist of mutually orthogonal dipole antennas, with one antenna generally parallel to the instrument's longitudinal axis, it is to be clearly understood that other example processes may be derived for instruments having other than triaxial dipole antennas. It is only necessary to have a sufficient number of such antennas such that the apparent conductivity tensors described with reference to FIGS. 2A and 2B can be derived. It should also be understood that the term “dip” as used herein may mean relative inclination of formation layers with respect to a plane normal to the longitudinal (Z) axis of the well logging tool. In actual well logging conditions, as explained above, the trajectory of the wellbore may not be vertical, so that “dip” becomes a relative term. Such relative dip may be resolved into actual formation geodetic dip and azimuth by determining the geodetic orientation of the well logging instrument using directional sensors (therein or in adjacent instruments) and well known survey calculation methods.

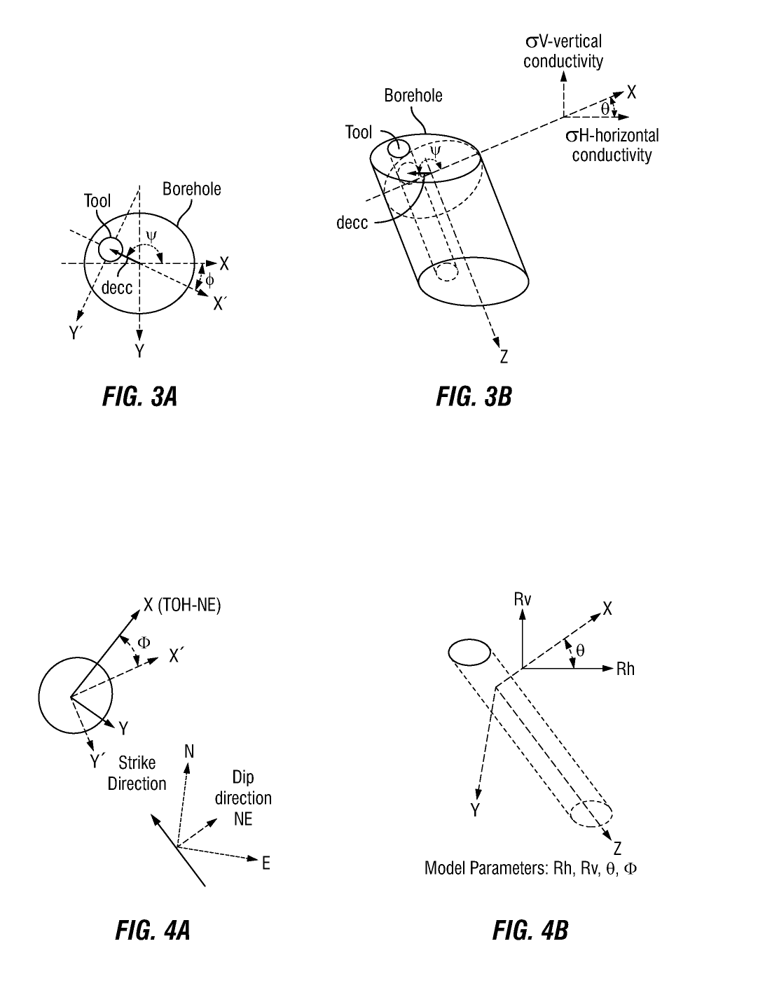

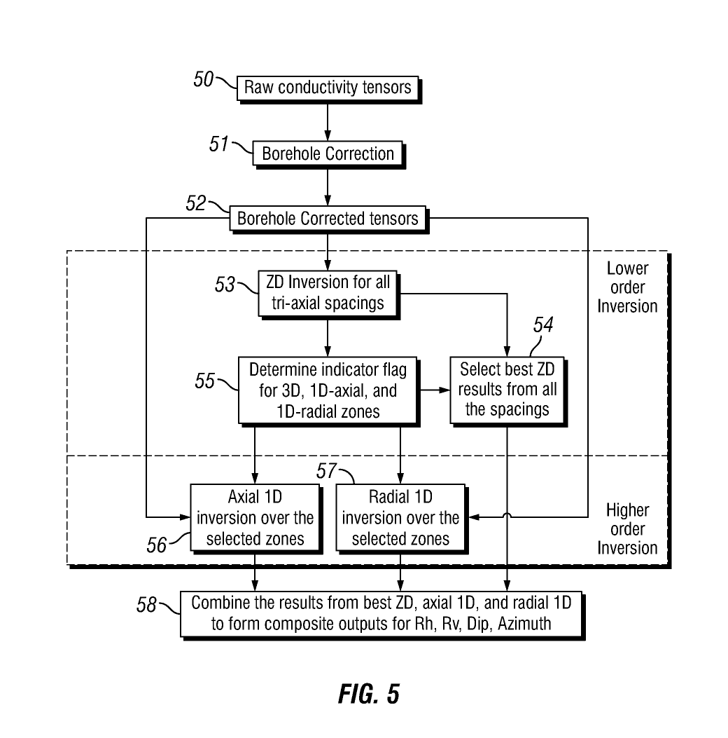

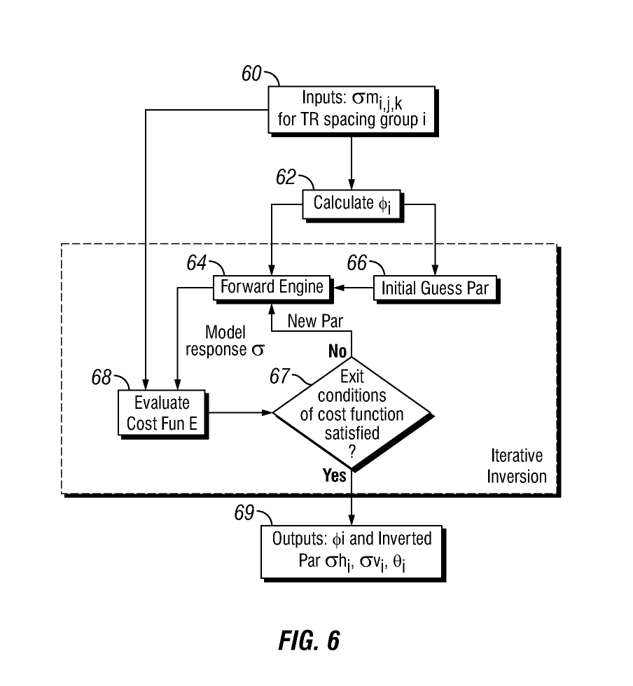

FIG. 5 is a flow diagram for an example of the above-described hierarchical processing. In the present example, lower order processing may be performed first to determine appropriate zones, if any, for further, higher order processing. At the end of the procedure, the results from the best ZD, axial 1D, and radial 1D inversions may be combined to form composite outputs. The description of the lower order processing shown in FIG. 6 explained in more detail below. Briefly, input data from a multiaxial induction tool disposed in a wellbore may be accepted as input 50 to the process. At 51, borehole corrections may be made to the measurements (see FIG. 3A and FIG. 4A), resulting, at 52, with borehole corrected tensors. At 53, ZD inversion may be performed on all the measurements. At 55, a selection procedure may be used to determine which formation zones are likely to provide good inversion results when processed by 1-D axial or 1-D radial inversion processing. At 54, a selection process may identify the best results from the ZD inversion at 53. At 56, and 57, respectively, those zones identified as likely to provide good results may be 1-D axial and 1-D radial inversion processed. At 58 a composite output may be provided to obtain inversion results for Rh, Rv, dip angle and dip azimuth.

FIG. 6 is a block diagram for an example ZD inversion algorithm (which may be used such as at 53 in FIG. 5). In the present example, at 60, direct measurements from the various receivers on the well logging tool may be acquired. In some embodiments, to invert for the formation parameters (σh, σv, θ, Φ), an iterative minimization algorithm can be used. Based on various methods, such as the algorithm described in U.S. Patent Application Publication No. 2010/0198569, incorporated herein by reference, the formation azimuthal angle Φ can be computed from the measured conductivity tensor σm(i,j,k), as shown at 62. Here, the indices i, j, k, are for each transmitter spacing to a receiver, transmitter orientation, and receiver orientation, respectively. The foregoing procedure can enable the elimination of one free parameter from the inversion and thereby may improve the robustness of the inversion, leaving an inversion that may need only to invert for three parameters (σh, σv, θ) which minimizes a cost function.

In example embodiments, the inversion may be repeated for every transmitter to receiver spacing. For each spacing i, a set of formation parameters σhᵢ, σvᵢ, θᵢ, and Φᵢ may be obtained. There are various ways to form transmitter-to-receiver spacing groups. In one example, a simple method can be a spacing group consisting of data from only a single transmitter to receiver spacing. For the purpose of enhancing signal-to-noise ratio, more than one triaxial spacing data can be grouped into a spacing group. For example, the data for the following spacings can be grouped together:

| | |
|---|---|
| Group 1 | 15″ + 21″ |
| Group 2 | 15″ + 21″ + 27″ |
| Group 3 | 21″ + 27″ + 39″ |
| Group 4 | 27″ + 39″ + 54″ |
| Group 5 | 39″ + 54″ + 72″ |
| Group 6 | 54″ + 72″ |

In some examples, the effective transmitter to receiver spacing of each group can be the averaged spacing of the constituent measurement sets in the group.

A cost function may then be constructed at 68 to relate the cost to the degree of match between the measured data 60 and modeled data 64. The forward modeling algorithm can use analytic formulae to compute the model triaxial response. Example analytic expressions for triaxial responses in uniform dipping anisotrpic formation are known in the art, such as those described in, Moran, J. H. and Gianzero, S. C., “Effects of Formation Anisotropy on Resistivity-Logging Measurements”, Geophysics, 44, (1979), pp. 1266-1286. There are a number of ways to construct the cost function, with some being more efficient than others. An example cost function may be expressed as:

$$E = {\sum }_{i , j , k} {{w}_{i , j , k} ( σ {m}_{i , j , k} - {σ}_{i , j , k} )}^{2} , \qquad Eq . ( 1 \text{-} 1 )$$

where the w_{i,j,k} is weighting coefficient, σm_{i,j,k} is the measured conductivity tensor and σ_{i,j,k} is the modeled conductivity tensor.

An example of the weighting function w_{i,j,k} may be expressed in terms of standard deviation of the sonde error measurement, σstd_{i,j,k}, as:

$${w}_{i , j , k} = Max ( 0 , [ 1 - \frac{σ {std}_{i , j , k}}{abs ( σ {m}_{i , j , k} )} ] ) \qquad Eq . ( 1 \text{-} 2 )$$

The above expression of a weighting function will make w_{i,j,k}≈1, if the amplitude ratio between sonde error standard deviation and the measurement is near 0. The weighting function will decrease as the amplitude ratio increases and w_{i,j,k}≈0 if the sonde error is approaching the same magnitude of or larger than the measurement.

Other forms of the weighting function, such as w_{i,j,k}=1, may also produce reasonable results. In this case, the larger amplitude measurements tend to have higher influence on the cost function. Other forms of expression of cost function may also work as long as it could relate uniquely higher degree of match between the measurements and model values to lower cost. Additional examples of cost function expressions are given below:

$$\begin{matrix}E = {\sum }_{i , j , k} {w}_{i , j , k} {abs ( σ {m}_{i , j , k} - {σ}_{i , j , k} )}^{n} & Eq . ( 1 \text{-} 3 ) \\ E = {\sum }_{i , j , k} {{w}_{i , j , k} ( σ {m}_{i , j , k} - {σ}_{i , j , k} )}^{m} , m = even number & Eq . ( 1 \text{-} 4 )\end{matrix}$$

The minimum number of measurements that enter into the cost function should equal the number of unknown model parameters to be inverted. Usually, more measurements are available and may be used to enhance the statistical precision of the inversion process.

Starting from a set of initial estimate of model parameter values, at 66, a minimization algorithm may be used to determine the values of the inverted model parameters that produce the lowest possible value of the cost function. A non-linear least squares algorithm, such as the algorithms described in Levenberg, K. “A Method for the Solution of Certain Problems in Least Squares.”, Quart. Appl. Math. 2, 164-168, 1944 or Marquardt, D. W.,“An Algorithm for Least-Squares Estimation of Nonlinear Parameters”, J. Soc. Ind. Appl. Math., Vol II, No. 2., pp. 431-441 (1963), can be used to search for the model parameter values that minimize the cost function in Eq. (1-1) through an iteration process. For example, for a given n-th iteration, the algorithm will compute the cost function, Eₙ, from the current model parameters and also the difference between the current cost function and the previous cost function, ΔE=abs(Eₙ−Eₙ₋₁). The results may then be used to check whether any of the exit criteria are satisfied, at 67. Usually, the exit criteria specify the conditions in which the state of diminishing return is reached for continuing the iteration process. The exit criteria may include, but are not limited to, the following:
(a) Number of iteration>Nmax (a large number beyond which the inversion is considered taking too long to converge)
(b) Cost function Eₙ<ε1 (usually a very small constant below which the inversion is considered converged; error is below a level considered to be insignificant)
(c) ΔE<ε2 (usually a very small constant below which progress of convergence is considered too slow)

If the exit criteria are not satisfied, the algorithm can then determine the next set of trial parameter values in the direction of the steepest descent of E, and send the new parameter values to the forward engine to compute a new set of model responses. If any one of the exit criteria are satisfied, the algorithm can stop the iteration and output the then-current model parameters as a set of inverted parameters.

A non-linear least squares algorithm may not converge to the closest values of the actual formation parameters. Usually, for complex problems like the current one, the cost function may contain local minima. Accordingly, in some examples, the cost function may become locked into a local minimum and thus may produce incorrect inverted model parameters. Therefore, the robustness of such an algorithm may depend on the selection of the initial model parameter values. For a robust inversion, the initial model parameter algorithm may be selected to produce a set of initial parameter values such that the cost function is very close to the global minimum.

A coarse grid search strategy may be used to obtain the initial model parameters for σh, σv, and θ. The coarse grid values for rh (or 1/σh) parameters, rhi, may be obtained using σzz components of the input conductivity tensors and model σzz through an interpolation routine. A 7-point coarse grid for vertical resistivity, Rv, (or 1/σv) may be constructed through the σh/σy ratio, ratio_cg. The coarse grid may have the following values: ratio_cg=[1.0, 1.3, 1.7, 2.0, 3.0, 5.0, 10.0]. A 10-point coarse grid for dip angle, dip_cg, may be adopted. The dip_cg grid may have the following values: dip_cg=[0, 10, 20, 30, 40, 50, 60, 70, 80, 90].

The initial parameter model algorithm may loop through all the combination of the coarse grid for rh, ratio, and dip angle and compute the cost function. The parameter values at the coarse grid that produce the lowest cost function are obtained at 66, together with calculated azimuth angle θi as initial guess values for the iterative inversion process.

The specific range and density of the initial parameter coarse grids presented here appear to represent a good compromise based on the result of many trials. A wider range of parameter values and more dense coarse grids will produce more robust initial parameter values at the expense of higher computational cost.

Various methods may be used for determining flags, (i.e., as shown at 55 in FIG. 5) for 3D, 1D-axial, and 1D-radial formations. In other words, a method for determining flags indicating the complexity of the formation based on the outputs of the ZD inversion can be used. In example embodiments, the actual formation is 3-dimensional and would require a full 3D model for accurate inversion. To make the processing be practical, simplified assumptions about the formation may be made in order to timely to process the data. There are two classes of such processing. One is called 1D-axial and the other is 1D-radial.

The 1D-axial model generally assumes the formation within the processing window consists of parallel anisotropic layers each with different Rh and Rv values. Furthermore, the dip and azimuth of all layers within the window are the same. Essentially, the formation Rh and Rv are allowed to have variation only in the axial direction. This model is used to obtain sharper vertical resolution Rh and Rv logs because it accounts for the (adjacent) shoulder bed effects.

The 1D-radial model assumes the formation is anisotropic without axial layers, instead with concentric radial layers, each with different Rh and Rv values. This model may be be used to process data with invasion condition to obtained resistivity of virgin and invaded zones and the diameter of invasion.

Compared with ZD processing, the above 1D processing models are of higher order. If the formation condition fit the model requirements, the higher order processing could improve certain aspect of the basic ZD logs. The 1D-axial model will generally have sharper Rh and Rv logs. The 1D-axial model will generally have virgin (uninvaded zone) and invaded zone resistivity. However, it may not be apparent for which zones these higher order processing models are applicable. In the unknown subsurface formations, these higher order models may not yield better results if the underline higher order model assumptions are not met. In fact, some modeling and research shows that using the 1D-axial processing yields worse results than ZD in some 3D formations. Accordingly, it is helpful to identify which zones are fully 3D formations, which zone fits 1D-axial model, and which zone fits the 1D-radial model. Indicator flags for these three different zones may be created to delineate the zone boundaries.

The purpose of these indicator flags are two-fold: One is to ensure high quality of the higher order inversion by running the higher order inversion only in the zones where the models fit the subsurface formation condition. The second is to save time because the higher order inversion usually is very time consuming. Test experience shows that running thousands of feet of data through 1D-axial inversion would take many hours. However, for the most part, the formation is fully 3D and 1D-axial results did not show any improvement over the already existing ZD results. In many occasions due to rapid change in dip and azimuth of the formation, the 1D-axial inversion shows worse results than ZD. Accordingly, it is desirable to identify the depth ranges over which 1D inversions can provide better results.

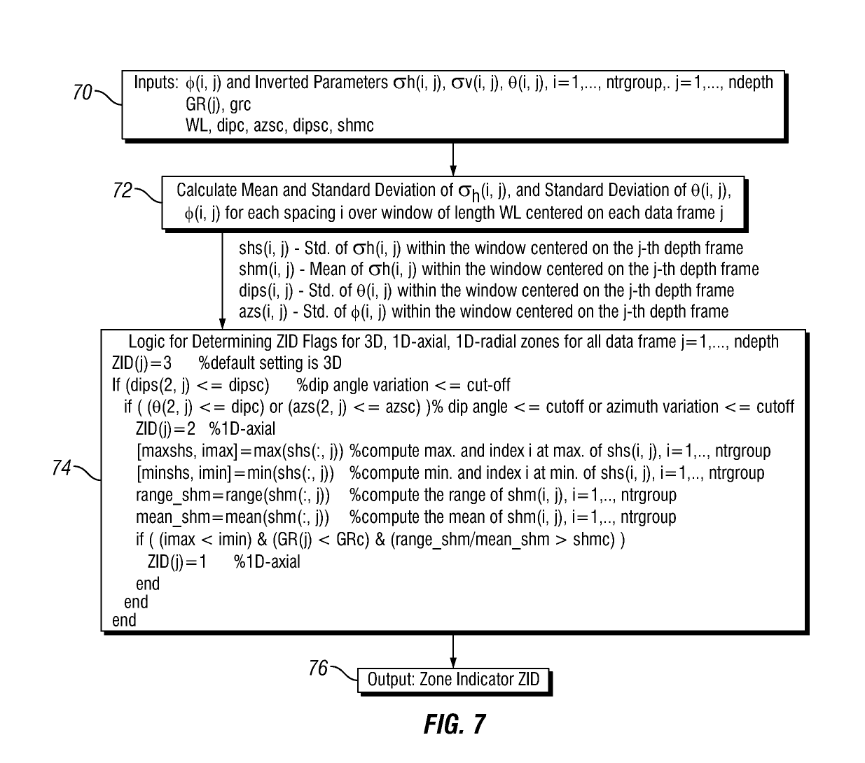

An example technique to derive the formation indicator flags is described with reference to the block diagram of FIG. 7. Let Rh(i,j), Rv(i,j), Dip(i,j), Az(i,j) be the results from the i-th T-R spacing group ZD inversion at j-th depth frame. A first step may be to convert the resistivity into conductivity at 70. At 72, the mean and standard deviation of the ZD outputs may be calculated using a sliding window of length WL centered on each data frame j. Specifically, in a particular embodiment, the following intermediate items may be computed:
shs(i,j)—Standard deviation of σh(i,j) within the window centered on the j-th depth frame
shm(i,j)—Mean of σh(i,j) within the window centered on the j-th depth frame
dips(i,j)—Standard deviation of θ (i,j) within the window centered on the j-th depth frame
azs(i,j)—Standard deviation of φ(i,j) within the window centered on the j-th depth frame
i=1, . . . , ntrgroup, j=1, . . . , ndepth

These intermediate results then may the be used, at 74 in a second step to determine a formation indicator flag ZID(j) at each depth frame j, as shown at 76. ZID is a tri-level flag which take the following values.

$$\begin{matrix}ZID = 1 & \begin{matrix}indicates 1 D \text{-} radial zone suitable for running \\ 1 D radial inversion ,\end{matrix} \\ = 2 & \begin{matrix}indicates 1 D \text{-} axial zone suitable for running \\ 1 D \text{-} axial inversion ,\end{matrix} \\ = 3 & \begin{matrix}indicate 3 D zone with significant variation in dip \\ azimuth\end{matrix}\end{matrix}$$

In example embodiments, the following control parameters may be used in the logic of defining the ZID flag.
dipc—cut off value for θ (i,j) below which the formation dip angle is consider very small such that the formation azimuth will be undefined
dipsc—cut off value for dips(i,j), which is the standard deviation of θ (i,j), above which the formation dip angle is considered highly variable
azc—cut off values for azs(i,j), which is the standard deviation of φ (i,j), above which the formation azimuth angle is considered highly variable
grc—cut off value for GR below which the formation is considered to be permeable
shmc—cut off value for normalized variation of shm(i,j)

In some examples, the ZID flag value may be set to 3 as default. The following criteria can be used to identify the 1D-axial and 1D-radial zones at any given depth index j.
If the dips(2,j)<=dipsc, i.e. dip angle variation is small,

and If either θ (2,j)<=dipc or azs(2,j)<=azsc, i.e. dip angle is small or azimuth angle variation is small, then

set ZID(j)=2, i.e. 1D-axial zone

Compute the following intermediate items

```
    [maxshs, imax] = max(shs(:,j)), maxshs and imax are max.
    and index i at max. of
shs(i,j), i=1,..,ntrgroup
    [minshs, imin] = min(shs(:,j)), minshs and imin are min.
    and index i at min. of
shs(i,j), i=1,..,ntrgroup
    range_shm=range(shm(:,j)), range_shm is the range of
    shm(i,j),i=1,..,ntrgroup
    mean_shm=mean(shm(:,j)),mean_shm is the mean of
    shm(i,j), i=1,..,ntrgroup
    If imax < imin , i.e. short spacing should have larger
    variation in σh than long
spacing,
    and GR(i) < grc , i.e., GR indicate permeable zone,
    and range_shm/mean_shm > shmc, i.e. significant
    variation in the normalized
    mean value of shm(i,j), then
      Set ZID(j)=1, i.e. 1D-radial zone
    End
  End
End
```

In this example, for the purpose of illustration, a gamma ray (GR) log and a cutoff value may be used in the above algorithm to define permeable formation zones. In other embodiments, any other log measurement that could indicate permeable formation zones could be used for this purpose, in addition to or instead of the GR log.

In the present example computing optimal ZD outputs may be performed. In the present example a method may be used for producing the best σh, σv, θ and t from the six spacing group ZD inversion results described with reference to FIG. 5, shown at 54 in FIG. 5. In some examples, the guiding principles of selecting the best ZD results can be the following: (1) In the 3D formation, results from the short spacing suffer the least 3D effects and therefore are more accurate; (2) In a 1D-axial formation, short spacing may yield better vertical resolution logs than the long spacing; and (3) In a 1D-radial formation which as significant invasion effects, the longer spacing yield better results.

In example embodiments, the second transmitter to receiver (T-R) spacing group (15″+21″+27″) may be chosen to represent the short spacing and the 5th T-R spacing group (39″+54″+72″) may be chosen to represent the long spacing. Essentially, the best ZD results come from the second T-R spacing group if the formation is 3D or 1D-axial and from 5th T-R spacing group if the formation is 1D-radial.

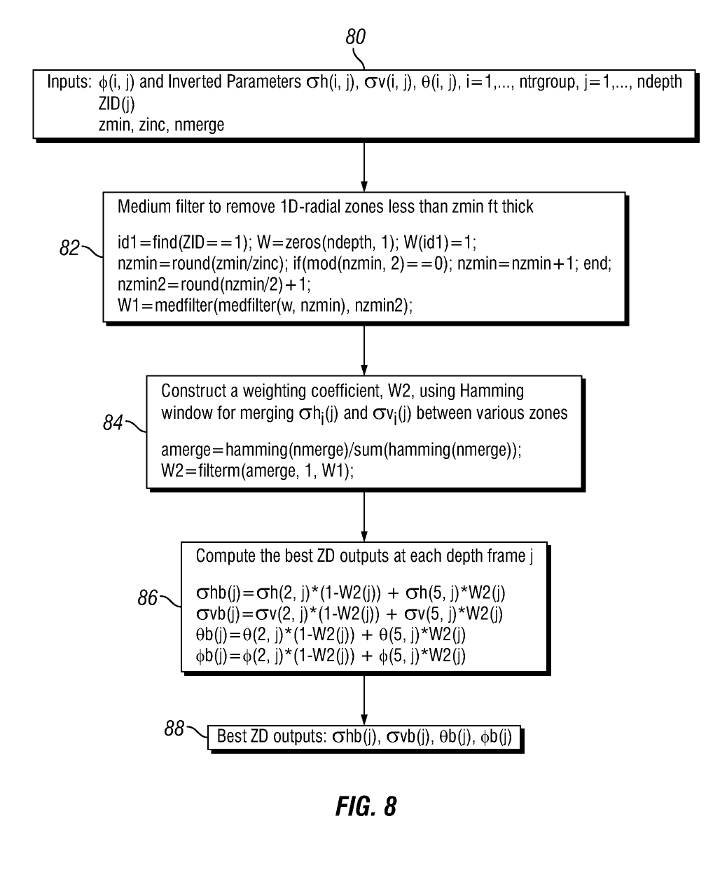

An example ZD selection algorithm is shown in the block diagram on FIG. 8. The input data, at 80, are the ZD results σh(i,j), σv(i,j), θ (i,j), Φ (i,j), and the formation indicator flag ZID(j), i=1, . . . , ntrgroup, j=1, . . . , ndepth. The algorithm consists of three steps. 82 and 84 are preparation steps that may be designed to create a smooth transition between 1D-radial zones and other zones, and also to eliminate, if any, the sporadic thin zones within or near large zone boundaries. The 3rd step is to merge the short and long spacing data according to the conditioned ZID flag.

At 82, a weighting coefficient array W may be constructed. W may have the same length, ndepth, as the data. W is assigned value of 1 in the zones where ZID(j)=1 (1D-radial zone) and 0 elsewhere. To eliminate the sporadic thin 1D-radial zones sometimes occurs around the thick bed boundary or within a thick bed, a nested median filter are applied to W. The length of the median filter may be controlled by two input parameters zmin and zinc, which specify the minimum length (in feet) of the 1D-radial zone and the depth sampling increment, respectively. Usually zmin=10 ft will produce reasonable results. Using zmin and zinc, two odd numbers nzmin and nzmin2 are obtained as the length of the main and nested medium filter.
nzmin=round(zmin/zinc) for converting zmin to number of depth samples. Round(x) is an operator that round x to the nearest integer.

To convert nzmin to odd number, the following check may be performed;

If (mod(nzmin,2)==0) then
nzmin=nzmin+1
end

Here mod(a,b) is an operator that produce the remainder of a divided by b.
nzmin2=round(nzmin/2)+1
W1=medfilter(medfilter(w,nzmin),nzmin2)

Here, medfilter(x,n) is an operator symbol that produces length n median filter output on input array x.

The W1 is the output of the nested median filter of the W. The median filter operation effectively remove thin (thickness less than zmin ft) zones of either W=1 or W=0 by assigning the W value of the thin zone to the surrounding thicker zone's value.

In a second step, the W1 array is filtered by a normalized Hamming window filter of length nmerge, which is a control parameter settable by the user. nmerge is odd number for the number of points over which the short spacing results and long spacing results are merged together smoothly. Usually nmerge should cover only a few feet of the data. The coefficient of the normalized Hamming window filter, amerge, is given as:

amerge=hamming(nmerge)/sum(hamming(nmerge))

Here, hamming(n) is a function that produces a Hamming window of length n and sum(x) is a function that produces the sum of the array x
Let W2 be the filtered W1 array given as
W2=filterm(amerge,1,W1)

Here, filterm is an operator symbol that would convolve the input array W1 with the filter coefficient amerge. The symbol filterm will also apply a shift to remove the filter delay. At 86, the best ZD outputs at each depth frame j may be computed via the following formula:

σhb(j)=σh(2,j)*(1−W2(j))+σh(5,j)W2(j)

σvb(j)=σv(2,j)*(1−W2(j))+σv(5,j)*W2(j)

θb(j)=θ(2,j)*(1−W2(j) +0(5,j)*W2(j)

σb(j)=φ(2,j)*(1−W2(j))+φ(5,j)*W2(j)

and such best ZD values may be output at 88.

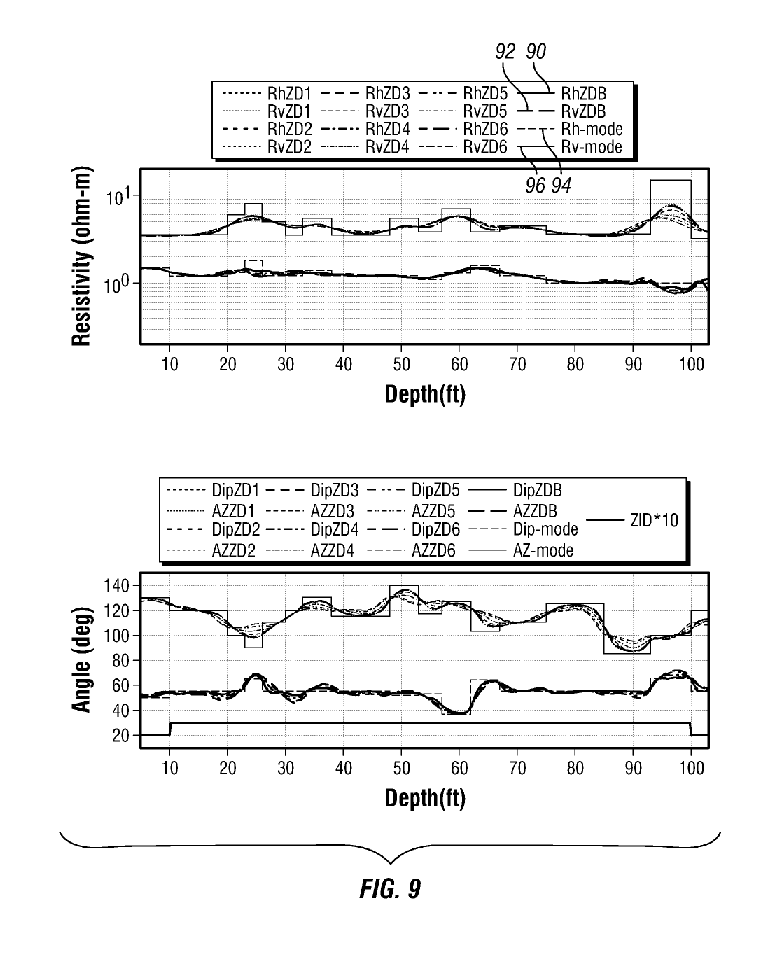

Finite difference code was used to generate model data for 3D formation based on some typical field condition. FIG. 9 shows an example of ZD results from such model data. The model formation consists of 16 layers of anisotropic formation each with different Rh, Rv, dip and azimuth value. The model parameters for Rh, Rv are shown in the top track as dashed red and blue curves, respectively. The ZD inverted Rh and Rv logs from all 6 spacings are shown as the thin curves. The best ZD Rh and Rv logs are the thick solid curves 90, 92, respectively. The model parameters for dip and azimuth are shown in the bottom track as curves 94 and 96, respectively. The ZD inverted dip and azimuth logs from all 6 T-R spacings are shown as the thin curves. The best ZD dip and azimuth logs are the thick solid red and blue curves, respectively. The formation indicator flag ZID*10 is plotted as solid green curve. Other than both end zones, the ZID flag from 10 to 100 ft has value of 3, indicating 3D formation.

Due to shoulder bed effects, the ZD inversion results did not fully reproduce the model parameters. However, the inverted logs match the respective model parameters remarkably close. As expected, the short spacing results are closer to the model parameter than the long spacing. The best ZD results for this example are essentially the short spacing results.

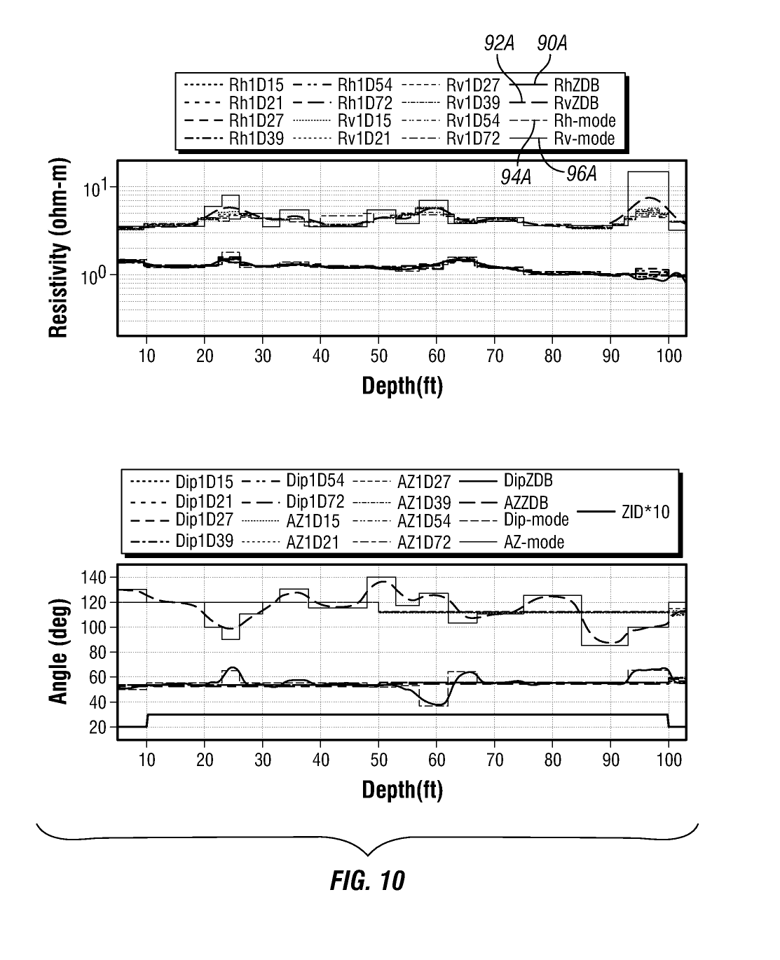

This model data set may also be processed by 1D-axial inversion. FIG. 10 shows a comparison of the 1D-axial inversion results with best ZD results. The model parameters for Rh, Rv are shown in the top track as curves 94A, 96A, respectively. The 1D-axial inverted Rh and Rv logs from all 6 spacings are shown as the thin curves. The best ZD Rh and Rv logs are the thick solid blue and red curves, respectively. The model parameters for dip and azimuth are shown in the bottom track as dashed blue and red curves, respectively. The 1D-axial inverted dip and azimuth logs from all 6 spacings are shown as the thin curves. The best ZD dip and azimuth logs are the thick solid red and blue curves, respectively.

The 3D model data example demonstrated that in 3D formation ZD results may actually be better than 1D-axial results. The ZD's Rh and Rv are closer to the respective model parameter value than 1D-axial results. The 1D-axial's dip and azimuth values essentially equal to the averaged ZD results over the processing window.

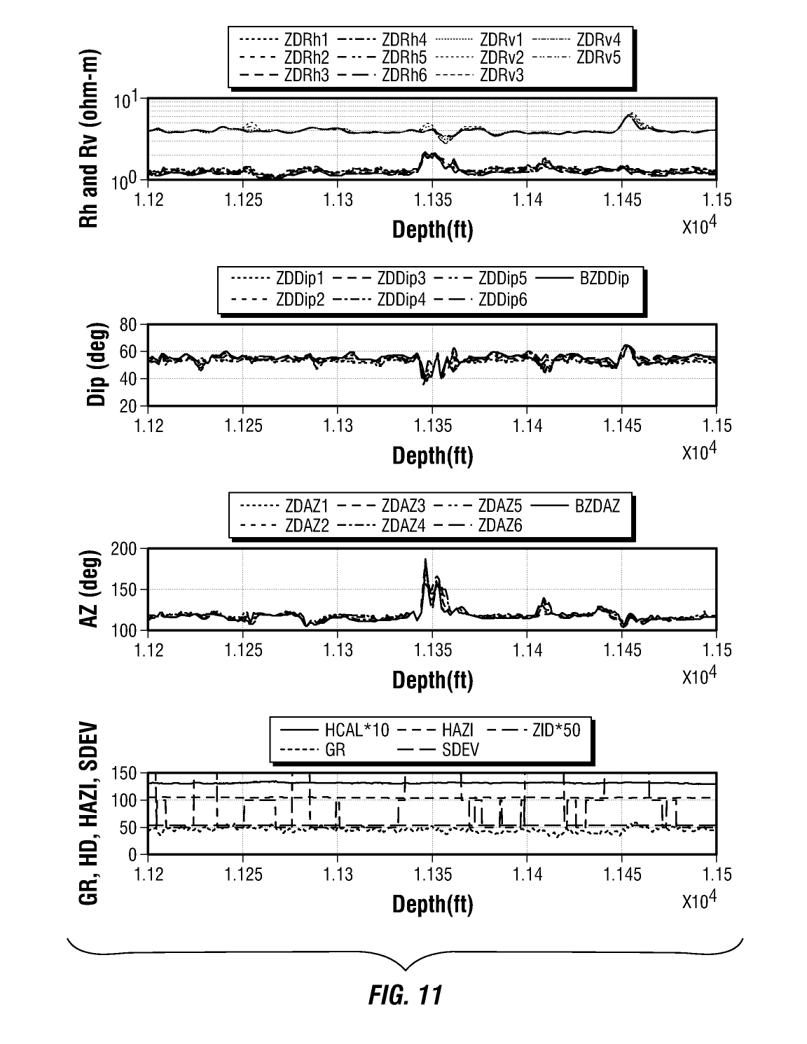

FIG. 11 is a field data example of ZD processing and best ZD logs. The top track is the best ZD Rh and Rv logs in thick blue dash and thick red solid curves, respectively. The ZD Rh and Rv logs from all 6 spacings are shown as the thin curves. The second track shows the best ZD dip in thick red curve and the dip from all 6 spacings in thin curves. The third track shows the best ZD azimuth in thick red curve and the azimuth from all 6 spacings in thin curves. The forth track shows hole diameter (HCAL*10) in blue, GR in green, hole azimuth in red, sonde deviation in cyan, and the formation flag ZID in magenta.

The ZID flag shows many zones of 3D formation (ZID=3), such as 11340-11370 ft., and many zones of 1D-radial and 1D-axial formation. The 3D zones clearly show large dip and azimuth variation. The best ZD logs in the 3D zones match the short spacing results. The long spacing results in the 3D zones clearly show much lazy response consistent with the vertical resolution of the long spacing measurements. In the 1D-radial zones, such as 11300-11340ft, the log variation over depth is small but a clear separation between long spacing and short spacing log are discernible. In the 1D-radial zones, the best ZD logs match the long spacing results.

Example methods as explained above may make it possible to obtain reasonably accurate multiaxial induction well logging models of subsurface formations while well logging operations are underway (i.e., the tool is making measurements in the wellbore).

FIG. 12 shows an example computing system 101 in accordance with some embodiments for carrying out example methods such as those explained above. The computing system 101 can be an individual computer system 101A or an arrangement of distributed computer systems. The computer system 101A includes one or more analysis modules 102 that are configured to perform various tasks according to some embodiments, such as the tasks depicted in FIGS. 3A through 8. To perform these various tasks, an analysis module 102 executes independently, or in coordination with, one or more processors 104, which may be connected to one or more storage media 106. The processor(s) 104 may also connected to a network interface 108 to allow the computer system 101A to communicate over a data network 110 with one or more additional computer systems and/or computing systems, such as 101B, 101C, and/or 101D (note that computer systems 101B, 101C and/or 101D may or may not share the same architecture as computer system 101A, and may be located in different physical locations, e.g. computer systems 101A and 101B may be on a ship underway on the ocean, in a well logging unit disposed proximate a wellbore drilling, while in communication with one or more computer systems such as 101C and/or 101D that are located in one or more data centers on shore, other ships, and/or located in varying countries on different continents).

A processor can include a microprocessor, microcontroller, processor module or subsystem, programmable integrated circuit, programmable gate array, or another control or computing device.

The storage media 106 can be implemented as one or more non-transitory computer-readable or machine-readable storage media. Note that while in the example embodiment of FIG. 12 storage media 106 is depicted as within computer system 101A, in some embodiments, storage media 106 may be distributed within and/or across multiple internal and/or external enclosures of computing system 101A and/or additional computing systems. Storage media 106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 101 is only one example of a computing system, and that computing system 100 may have more or fewer components than shown, may combine additional components not depicted in the embodiment of FIG. 12, and/or computing system 101 may have a different configuration or arrangement of the components depicted in FIG. 12. The various components shown in FIG. 12 may be implemented in hardware, software, or a combination of both hardware and software, including one or more signal processing and/or application specific integrated circuits.

Further, the acts in the methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

As to the example methods and steps described in the embodiments presented previously, they are illustrative, and, in other embodiments, certain steps can be performed in a different order, in parallel with one another, omitted entirely, and/or combined between different example methods, and/or certain additional steps can be performed, without departing from the scope and spirit of the invention. Accordingly, such other embodiments are included in the invention described herein.

The example methods can comprise a computer program that embodies the functions described herein and illustrated in the flow charts. However, it should be apparent that there could be many different ways of implementing the example methods in computer or algorithmic programming, and the examples described herein should not be construed as limited to any one set of program instructions. Further, a skilled programmer would be able to write such a program to implement an example based on the flow charts and associated description in the application text. Therefore, disclosure of a particular set of program code instructions is not considered necessary for an adequate understanding of how to make and use the invention.

Example methods can be used with computer hardware and software that performs the methods and processing functions described above. Specifically, in describing the functions, methods, and/or steps that can be performed in accordance with the invention, any or all of these steps can be performed by using an automated or computerized process. As will be appreciated by those skilled in the art, the systems, methods, and procedures described herein can be embodied in a programmable computer, computer executable software, or digital circuitry. The software can be stored on computer readable media, such as non-transitory computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

Although specific embodiments of the method have been described above in detail, the description is merely for purposes of illustration. Various modifications of, and equivalent steps corresponding to, the disclosed aspects of the example embodiments, in addition to those described above, can be made by those skilled in the art without departing from the scope of the invention defined in the following claims, the scope of which is to be accorded the broadest interpretation so as to encompass such modifications and equivalent structures.

What is claimed is:

1. A method for logging a formation comprising:
obtaining a plurality of multiaxial electromagnetic conductivity measurements from the formation;
in a processor performing a zero-dimensional inversion on the plurality of conductivity measurements, yielding zero-dimensional inversion results;
in a processor identifying a first portion of results from the zero-dimensional inversion for processing with a higher-order inversion;
in a processor performing the higher-order inversion on the first portion, yielding higher-order inversion results; and
in a processor combining the zero-dimensional inversion results with the higher-order inversion results to form composite outputs for formation characteristics.

2. The method of claim 1, wherein the first portion of results comprises at least one of a 1-dimensional (1D) axial portion and a 1-dimensional radial portion.

3. The method of claim 2, wherein the higher-order inversion comprises at least one of 1D-axial inversion yielding 1D-axial inversion results and a 1D-radial inversion yielding 1D-radial inversion results.

4. The method of claim 3 further comprising identifying a second portion of the zero-dimensional inversion results and processing the second portion using the other of the 1D axial inversion and the 1D radial inversion.

5. The method of claim 4, further comprising performing 1D axial inversion on the first portion and 1D radial inversion on the second portion.

6. The method of claim 5, further comprising, selecting a best subset of results from the zero-dimensional inversion, and combining therewith results of the 1D axial inversion and the 1D radial inversion

7. The method of claim 6 wherein the selecting the best set of results from the zero-dimensional inversion comprises filtering 1-dimensional zones less than a selected thickness, generating a weighting function using Hamming window to merge vertical and horizontal conductivities, and selecting the best results based on weighted apparent vertical and horizontal conductivities.

8. The method of claim 1, wherein the formation characteristics comprise horizontal resistivity, vertical resistivity, formation dip, and formation azimuth.

9. A method for well logging subsurface formations penetrated by a wellbore, comprising:
moving a multiaxial electromagnetic induction well logging instrument along the interior of a wellbore;
actuating a multiaxial electromagnetic transmitter in the instrument to emit electromagnetic energy into the formations;
measuring multiaxial electromagnetic response of the formations at a plurality of axial distances from the transmitter to obtain a plurality of multiaxial electromagnetic conductivity measurements from the formation;
in a processor performing a zero-dimensional inversion on the plurality of conductivity measurements, yielding zero-dimensional inversion results;
in a processor identifying a first portion of results from the zero-dimensional inversion for processing with a higher-order inversion;
in a processor performing the higher-order inversion on the first portion, yielding higher-order inversion results; and
in a processor combining the zero-dimensional inversion results with the higher-order inversion results to form composite outputs for formation characteristics.

10. The method of claim 9, wherein the first portion of results comprises at least one of a 1-dimensional (1D) axial portion and a 1-dimensional radial portion.

11. The method of claim 10, wherein the higher-order inversion comprises at least one of 1D-axial inversion yielding 1D-axial inversion results and a 1D-radial inversion yielding 1D-radial inversion results.

12. The method of claim 10 further comprising identifying a second portion of the zero-dimensional inversion results and processing the second portion using the other of the 1D axial inversion and the 1D radial inversion.

13. The method of claim 12, further comprising performing 1D axial inversion on the first portion and 1D radial inversion on the second portion.

14. The method of claim 13, further comprising, selecting a best subset of results from the zero-dimensional inversion, and combining therewith results of the 1D axial inversion and the 1D radial inversion

15. The method of claim 14 wherein the selecting the best set of results from the zero-dimensional inversion comprises filtering 1-dimensional zones less than a selected thickness, generating a weighting function using Hamming window to merge vertical and horizontal conductivities, and selecting the best results based on weighted apparent vertical and horizontal conductivities.

16. The method of claim 6, wherein the formation characteristics comprise horizontal resistivity, vertical resistivity, formation dip, and formation azimuth.
